(19) United States
(12) Patent Application Publication
(10) Pub. No.: US 2017/0101014 A1
(43) Pub. Date: Apr. 13, 2017

(54) PowerEX

(71) Applicant: Cameron Mealad Shokri, Mckinney, TX (US)

(72) Inventor: Cameron Mealad Shokri, Mckinney, TX (US)

(21) Appl. No.: 15/242,606

(22) Filed: Aug. 22, 2016

Related U.S. Application Data
(60) Provisional application No. 62/238,700, filed on Oct. 8, 2015.

(51) Int. Cl. B60L 8/00; B60R 16/033; H01M 10/46

(52) U.S. Cl. CPC B60L 8/003; H01M 10/465; B60R 16/033; H01M 2220/20

(57) ABSTRACT

One of the major problems with the modern electric vehicle is the limited driving range. Part of that problem is due to the fact they utilize heavy batteries that require stationary charging. The Power Extender Setup technology corrects for some of these major shortcomings to improve the driving range.

Using an electric automotive motor like the one found in a Tesla vehicle one can adapt the configuration of a vehicle to extend the vehicle driving range. A Power Extender setup has the potential to extend the range of a traditional Lithium ion or nickel cadmium battery only setup. One of the downsides of modern hybrid and electric vehicles is the power storage capacity of the battery system. Another is the increased weight that these batteries create on a vehicle.

A vehicle utilizing power extender setup will increase the range by building solar panels into the roof, hood, and/or trunk of a vehicle. These panels can be layered and fold out into the sunlight when stationary. The top layer can also be active while driving which would feed power into a protein crystal battery pack that would recharge main power supply of the vehicle. The primary battery (protein crystal battery) could also be coupled with a traditional regenerative braking system like one found on a Toyota Prius for increased power generation during city driving.

The solar panel can also bypass the battery all together and feed power directly to the motor when highway cruising. The onboard computer would determine if there is enough power being generate to match the vehicle output on highway cruising. At which point the vehicle would automatically enter bypass mode using a direct connection to the motor. The bypass can also be activated manually when the vehicle runs out power to enter a limp mode to move the vehicle short distances at slow speeds. The majority of the time the car would operate the electric motor off the battery because the onboard solar charger would allow for a slower discharging of the primary power supply.

The protein crystal battery offers the added advantage of dramatically reducing the amount of time needed for a full charge as they charge much quicker than traditional lithium ion setups. The protein crystal battery would also increase energy storage capacity compared to lithium ion approach. The protein crystal battery pack would also dramatically decrease the weight of the vehicle making it more efficient. Disposal of these batteries would be more environmentally friendly as they are not toxic like lithium ion setups. All together this setup provides increased energy efficiency compared to traditional electric cars not utilizing the power extending technology.

1. I claim that this specified invented technology one can create an electric vehicle that has extended driving range compared to traditional electric cars.

2. Technology as in claim 1, further comprising of an electric car utilizing a solar panel to charge a protein crystal battery pack.

3. I claim that an onboard computer module with specific software can manage this technology for optimum specified use.
